(19) United States
(12) Patent Application Publication
(10) Pub. No.: US 2017/0166480 A1
(43) Pub. Date: Jun. 15, 2017

(54) LIGNOCELLULOSIC AND GEOPOLYMER COMPOSITE SYNERGIES AND POLYMER-BASED ADDITIVES FOR GEOPOLYMER COMPOSITE

(71) Applicant: LUKE HAVERHALS, PEORIA, IL (US)

(72) Inventor: LUKE HAVERHALS, PEORIA, IL (US)

(21) Appl. No.: 15/341,972

(22) Filed: Nov. 2, 2016

Related U.S. Application Data
(60) Provisional application No. 62/249,765, filed on Nov. 2, 2015.
(60) Provisional application No. 62/293,172, filed on Feb. 9, 2016.
(60) Provisional application No. 62/377,316, filed on Aug. 19, 2016.

(51) Int. Cl. C04B 28/00; C04B 16/02

(52) U.S. Cl. CPC C04B 28/006; C04B 16/02

(57) ABSTRACT

Methods for developing and exploiting material-based synergy is provided. The methods include utilizing in a geopolymer composite material production process a diluted metal hydroxide solution from a lignocellulosic composite material production process. The methods also include utilizing a concentrated and/or re-concentrated metal hydroxide solution in a lignocellulosic composite material production process and/or in a geopolymer composite material production process. The methods further include utilizing lignocelluslosic composite materials with geopolymer composite materials to produce superior products that include some or all of the benefits associated with each material.

### CROSS-REFERENCE TO RELATED APPLICATIONS

This application claims priority pursuant to 35 U.S.C. 119(e) to co-pending U.S. Provisional Patent Application Ser. No. 62/249,765, entitled “LIGNOCELLULOSIC AND GEOPOLYMER COMPOSITE SYNERGIES AND POLYMER-BASED ADDITIVES FOR GEOPOLYMER COMPOSITE,” filed Nov. 2, 2015, U.S. Provisional Patent Application Ser. No. 62/293,172, entitled “LIGNOCELLULOSIC COMPOSITES PREPARED WITH AQUEOUS ALKALINE AND UREA SOLUTIONS IN COLD TEMPERATURES SYSTEMS AND METHODS,” filed Feb. 9, 2016, and U.S. Provisional Patent Application Ser. No. 62/377,316, entitled “COLD AQUEOUS ALKALINE TREATMENTS FOR COTTON YARN AND RELATED SYSTEMS AND METHODS,” filed Aug. 19, 2016 the entire disclosures of which are incorporated herein by reference.

### FIELD

The present invention relates generally to systems for and methods of co-generating Lignocellulosic Composites (LCs) with Geopolymer Composites (GPCs). More specifically, the present invention is concerned with using alkali metal hydroxide-based solvents used in the production of LCs as starting materials for producing GCs.

### BACKGROUND

“Geopolymers” (or polysialates) are part of a class of ceramic-like materials that can be made from a liquid phase at ambient temperatures. Geopolymers are inorganic polymers that comprise edge-sharing silicate (SiO₂) and aluminate (AlO₄—) tetrahedra containing charge-balancing Group I cations and water molecules found in nano-scale pores within the material. Their chemical formula can be written as M₂O·Al₂O₃·4SiO₂·11H₂O, where M is a Group I metal such as lithium (Li), sodium (Na), potassium (K), or cesium (Cs), but is usually either sodium or potassium. Geopolymers are rigid, hydrated, nanoporous, nanoparticulate, aluminosilicate polymers that can be utilized to create amorphous, cross-linked, impervious, acid-resistant, 3-D structures.

“Geopolymer Composites” (“GPCs”) are composite materials that include a geopolymer matrix and reinforcing fibers and/or other aggregates and additives. GPCs provide several advantages over more traditional materials. For instance, ordinary Portland cement (OPC) liberates approximately 0.95 tons of CO₂ for every ton of OPC produced while GPCs liberate only about 0.25 tons of CO₂ per ton of GPCs produced. This represents an approximately 75% reduction in CO₂ emission for GPCs relative to OPC. In addition, as shown in Table 1, below, the mechanical properties of GPCs are significantly superior to those of traditional OPC.

TABLE 1
Comparison of Mechanical Properties
of Portland Cements (OPC) with (GPC)

| Property | OPC | GPC |
|---|---|---|
| Compressive strength (MPa) | 60 | 100-120 |
| Flexure Strength (MPa) | 5-6 | 10-15 |
| Density (g/cc) | 2.7 | 1.4 |
| Setting time (days) | 28 | 1 |

Based on the above described benefits of GPCs over OPC, a major potential use of GPCs, worldwide, is for large infrastructures such as bridges, buildings, and roads. In fact, GPCs offer a unique, disruptive, material technology to traditional, high embodied energy binders, like cement and asphalt, that are presently exclusively utilized to construct buildings, bridges, and roadways. The invention disclosed is an improvement to existing methods to produce GPCs for a variety of civil infrastructure components because co-generating GPCs with recycled solvents from LC production reduces the cost of GPC production.

Background information for producing GPC material is disclosed at Colloids and Surfaces A: Physicochemical and Engineering Aspects Volume 269, Issues 1-3, 1 November 2005, Pages 47-58 “Understanding the relationship between geopolymer composition, microstructure and mechanical properties” Peter Duxson, John L. Provis, Grant C. Lukey, Seth W. Mallicoat, Waltraud M. Kriven, Jannie S. J. van Deventer.

The raw materials for making GPCs can come from relatively clean sources, such as clays (e.g. kaolinite), or from waste materials, such as fly ash, slag, glass cullet, or biomass ash. Consequently, it would be beneficial to develop synergies with GPC production and other industrial productions so that large amounts of waste, such as type F fly ash from coal plants, can be utilized in the production of GPCs rather than being deposited in landfills and/or otherwise being disposed of.

“Lignocellulosic Composites” (LCs) are composite materials that have also been recently developed. Already, a wide variety of unique LCs have been demonstrated that are based on the establishment of new hydrogen binding between ‘activated’ cellulose and lignocellulosic fiber reinforcements. ‘Activated’ cellulose comes from cellulose-containing materials (e.g., cotton, flax, kraft pulp) that have been at least partially solubilized by an appropriate ion-containing solvent at apposite conditions. Activated cellulose is able to flow because of solvent-assisted disruption to intermolecular (and intramolecular) hydrogen bonding within the material thereby creating an altered cellulosic matrix. Activated cellulose can then be mixed with reinforcement materials (i.e., loose fibers and organic particles) or can be infused into prefabricated materials such as biobased mats composed of high aspect ratio materials that may or may not contain particulate matter. Upon mixing with fibrous materials and particles, activated cellulose coats individual materials such that they are ‘welded’/‘cemented’/‘glued’ into a continuous composite network material. Fibrous and particulate materials can include, but are not limited to, natural biobased materials such as lignocellulose (e.g., wood, hemp, flax, et cetera), proteins (e.g., DDGs, silk, keratin, et cetera), and/or ‘functional’ materials (e.g., magnetic micro and nanoparticles, conductive carbons, fire retardant clays, conductive polymers, et cetera).

LCs are an inexpensive but highly functional composite material. Unfortunately, as is often the case with new materials, the infrastructure does not yet exist to utilize this new material to its fullest extent. Consequently, it would be beneficial to develop synergies with LC production and other industrial productions to increase incentives for, and reduce risks associated with, building such infrastructure.

### SUMMARY

The present invention comprises establishing and/or taking advantage of synergies with two or more industrial processes so as to increase the profitability of one or more of the processes and/or to improve one or more product produced by one or more of the processes. More specifically, the present invention pertains to GPCs and LCs.

In a preferred embodiment, the present invention includes identifying potential synergies. For instance, in some embodiments, the present invention includes identifying products, including by-products, of a first process and determining whether any of those products can be utilized in a second process. In some such embodiments, the present invention also includes determining whether use of the products in the second process provides economic and/or environmental advantages and/or whether it is feasible to utilize the products in the second process. For example, some first process products create new desirable characteristics for the second process while other first process products are not compatible with second processes and/or require extensive processing prior to being usable for second processes. Furthermore, some second process products are more expensive, less reliable, and/or otherwise less desirable when they are produced from first process products, especially when the first process products are waste products or some other by-product of the first process. Furthermore still, economies of scale for first processes are not always compatible with economies of scale for second processes. For instance, some first processes are incapable of producing sufficient quantities of first process products to accommodate second processes. In other instances, producing sufficient quantities of one or more first process product for the second process results in excess quantities of one or more other first process product.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a diagram of a first LC process and a second process in serial, where a byproduct of the first LC process is used in the second LC process.

FIG. 2 is a diagram of an LC process and GPC process in serial, where a byproduct of the LC process is used in the GPC process.

FIG. 3 is a diagram of two LC processes in parallel, using the same activating solution, to produce two different LC products.

FIG. 4 is a diagram of an LC process and a GPC process in parallel, using the same activating solution.

FIG. 5 is a diagram of an LC process and a GPC process in serial, to produce a product that includes both LC and GPC components.

FIG. 6 (FIGS. 6a and 6b) is a diagram of an LC/GPC product where the LC material 60 is a shell or mold into which the GPC material 50 is filled.

FIG. 7 (FIGS. 7a, 7b and 7c) is a diagram of an LC/GPC product where the LC material 60 forms a skeletal-like structure and the GPC material 50 coats the LC material 60.

### DETAILED DISCUSSION

### Co-Generation of GPC/LC

In some embodiments of the present invention, a newly discovered synergy that exists by “co-generation” of GPCs with LCs is exploited. As mentioned above, LCs have been demonstrated using an ‘activating’ solvent that disrupts intermolecular (and intramolecular) hydrogen binding within the cellulose-containing materials. Some examples of LC processes are disclosed in U.S. Provisional Patent Application Ser. No. 62/293,172, entitled “LIGNOCELLULOSIC COMPOSITES PREPARED WITH AQUEOUS ALKALINE AND UREA SOLUTIONS IN COLD TEMPERATURES SYSTEMS AND METHODS,” filed Feb. 9, 2016, and U.S. Provisional Patent Application Ser. No. 62/377,316, entitled “COLD AQUEOUS ALKALINE TREATMENTS FOR COTTON YARN AND RELATED SYSTEMS AND METHODS,” filed Aug. 19, 2016 the entire disclosures of which are incorporated by reference. This includes activating solvents that utilize Group I cations (most often lithium and sodium cations) with hydroxide anions (and with additional additives such as urea) as ‘activating’ constituents of the solvent. Group I cations with hydroxide anions are necessary components to produce GPC. To create the finished LCs, solvent agents can be removed by placing the fledgling LC (that contains solvent) into excess water. Activating constituents are transported from the LC to the excess water and form a diluted version of the ‘activating’ solvent. Chemicals from the biomaterials that comprise LCs (e.g., soluble salts, organic acid, simple sugars, oligosaccharides, et cetera) are also washed out into the diluted solution. This diluted solution is a ‘waste’ product of the LC process because it is no longer sufficiently efficacious to produce LCs unless it is re-concentrated. Although, in some embodiments, some or all of this waste product can be recovered and recycled for reuse in a subsequent LC process, it is advantageous in other embodiments to use some or all of the waste product from one or more LC process in one or more GPC processes.

Group I metal hydroxides, such as sodium hydroxides, are utilized with silicate (SiO₂) to create so-called ‘water glass’ solution, such as sodium silicate. In turn, the water glass solution is utilized to create GPCs. In some embodiments, silicate (SiO2) is added to the activating solution to create GPCs. In some embodiments, silicate (SiO2) is dissolved into the wash solution during the creation of LCs. Consequently, in some embodiments of the present invention, LC production waste products, such as diluted Group I metal hydroxide solutions, are utilized for producing GPCs. In this way, synergies of LC and GPC production are achieved through in-series co-generation of GPCs and LCs. In other embodiments, rather than using LC waste products, original and reconcentrated Group I metal hydroxide solutions are utilized to produce GPCs. In this way, synergies of LC and GPC production are achieved through in-parallel co-generation of GPCs and LCs. Co-generation is revolutionary in that it significantly decreases the cost of producing LCs and GPCs independently. Moreover, in some embodiments, GPC formulations are improved by the presence of new additives that are washed from natural materials during LC production. In some embodiments, synergies are further realized by placing one or more LC production facility near one or more GPC production facility.

### Standard Procedure for Geopolymer Production

The final molar ratio of the geopolymer constituents is 1 Al₂O₃: 1 Na₂O: 4 SiO₂: 11 H₂O. For example: 74.1 g waterglass with 25.9 g Metakaolin (required ratios) for a batch of approximately 100 g, where waterglass is a sodium silicate solution comprising 10.5% Na₂O with 26.5% SiO₂. The waterglass solution, comprising sodium hydroxide, fumed silica, and water is made according to the ratios listed above. The sodium hydroxide is mixed with water in a plastic beaker (to prevent etching). Once the hydroxide is dissolved, fumed silica is added and stirred until completely dissolved.

To waterglass, portions of the meta-kaolin are added and mixed with a high-sheer mixer. Add/mix/add/mix cycling repeats until all meta-kaolin is incorporated. Once all meta-kaolin is incorporated, the mix is placed in a mold, cellophane-wrapped, bagged, and let sit to cure for approximately 48 hours (at room temp).

In a preferred embodiment, the NaOH (with additional urea) for the GPC process is a byproduct from an LC wash solution.

Referring to FIG. 1, a diagram shows an exemplary embodiment where a first LC process and a second process are set up in serial to produce two different LC products. According to FIG. 1, a byproduct of the first LC process is used in the second LC process.

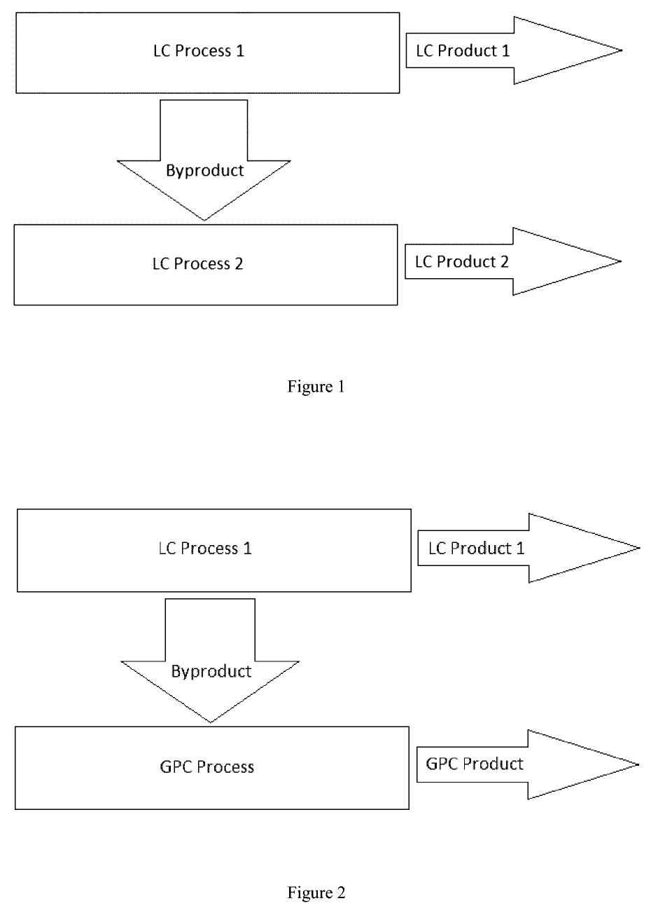

Referring to FIG. 2, a diagram shows an exemplary embodiment similar to the embodiment shown in FIG. 1, except that in FIG. 2, the second process is a GPC process (instead of a second LC process) and the GPC process produces a GPC product (instead of a second LC product). According to FIG. 2, a byproduct of the LC process is used in the GPC process.

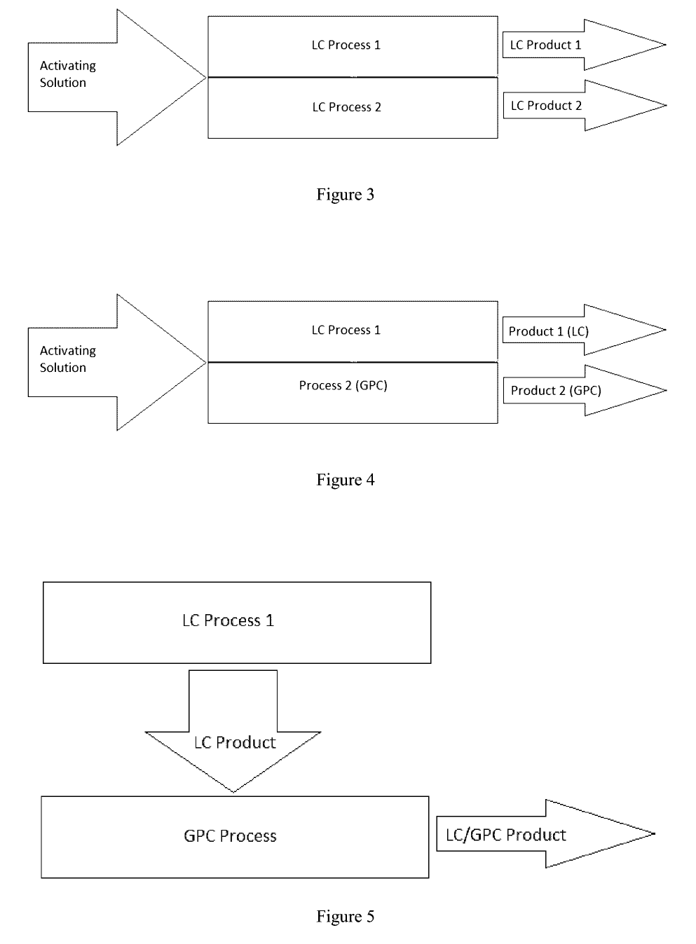

Referring to FIG. 3, two LC processes are shown operating in parallel to produce two different LC products. According to FIG. 3, both LC processes use the same activating solution to produce their respective LC products. Referring to FIG. 4, an LC process and a GPC process are shown operating in parallel, using the same activating solution.

### LC-Reinforced GPCs

In addition to advantages associated with co-generation, the production of GPCs physically near the production of LCs saves shipping costs in the production of superior products that utilize both LCs and GPCs as raw materials and/or otherwise utilizes both LCs and GPCs during the production process. Some such LC/GPC products exhibit enhanced properties (e.g., are strong and fire proof).

Some embodiments of LC/GPC products include bricks composed of GPC matrix and LCs as reinforcement. In one example, low-cost prototypes were produced. The prototypes used the LC process to create brick-shaped forms. The LC-based forms were then filled with GPC. The LC/GPC brick prototypes exhibited improved flexural performance compared to 100% GPC bricks of similar size and shape. The LC component in the prototype bricks acted as a structural reinforcement. One of ordinary skill in the art will appreciate that the LC component may be used to mold forms of any shape or size. In some such embodiments, LCs give shape to and/or otherwise mold the final part. In some embodiments, materials can be constructed such that GPC versus LC volume ratios are tailored for different applications. In some embodiments, co-generated GPC materials can be utilized as coatings on and/or as additional matrix material within LC constructs. Some such LC/GPC products exhibit the impressive tensile and flexural properties (especially given their mass) exhibited by LCs but also exhibit impressive compression properties and fire resistance exhibited by GPCs. In some embodiments, the synergies associated with co-generation of LC, GPC, and/or LC/GPC products provides favorable price points not otherwise available. In some such embodiments, these products are capable of being used worldwide as building materials, packaging, fire barriers, et cetera. In some such embodiments, LC/GPC products are capable of replacing traditional concrete/rebar products with LCs serving the same or similar purpose as rebar and GPCs serving the same or similar purpose as concrete.

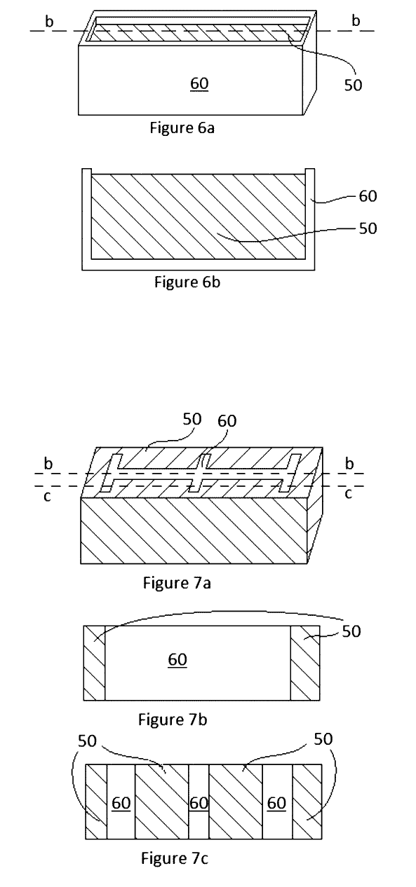

Referring to FIG. 5, an LC process and a GPC process are shown operating in serial. The product of the LC process is fed into the GPC process to produce a final product that includes both LC and GPC components. Referring to FIG. 6, an exemplary embodiment is shown. FIG. 6a is a perspective view of the LC/GPC brick-like product. FIG. 6b shows a cross-section of the LC/GPC brick of FIG. 6a along the line b-b. FIG. 6 is a diagram of an LC/GPC product where the LC material 60 is a shell or mold into which the GPC material 50 is filled. The final LC/GPC product where the LC material 60 forms an outer shell and the GPC material 50 fills a void in the shape of LC material 60 outer shell.

Referring to FIG. 7, another exemplary embodiment is shown. FIG. 7a is a perspective view of the LC/GPC product. FIG. 7b shows a cross-section of the LC/GPC product of FIG. 7a along the line b-b. FIG. 7c shows a cross-section of the LC/GPC product of FIG. 7a along the line c-c. FIG. 7 shows a diagram of an LC/GPC product where the LC material 60 forms a skeletal-like structure and the GPC material 50 coats the LC material 60.

Although the LC/GPC products shown in FIGS. 6 and 7 are brick-like in shape, a person of ordinary skill in the art will appreciate that the LC material 50 and the GPC material 60 can be combined in any size, shape or configuration such that the characteristics and properties of the combination product provides greatest advantage for intended purposes.

### Polymer-Based Additives for GPCs

In addition to combining GPCs with LCs, the present invention includes and utilizes new formulations for GPCs that contain dispersed polymers. In some embodiments, a water glass solution (which is a precursor in GPC production) is modified to contain dispersed ‘activated’ biopolymers (materials for which hydrogen bonding between individual polymer molecules has been disrupted). In some such embodiments, cellulose and starch (examples of water-insoluble and water-soluble carbohydrates, respectively) are utilized. In other such embodiments, bio-based (e.g., proteins, rubber) and/or synthetic polymers (e.g., aramids) are utilized. In some embodiments, water glass compositions are adjusted to include additives such as urea to enhance the dissolution of biopolymers such as cellulose. Water glass solutions are intentionally kept below 0° C. to minimize the degradation of biopolymers that is observed at higher temperatures.

Some formulations of the present invention, utilize polymers that have been activated and dispersed homogeneously within GPC formulations prior to curing. Some such activated polymers form networks that provide a new environment of the subsequent curing and production of geopolymer (inorganic) networks within GPCs. In some such embodiments, incorporation of dispersed polymers impacts GPC formulations in one or more way. For instance, in some embodiments, dispersed hydrophilic polymers facilitate enhanced retention of water for better curing GPCs. In other embodiments, dispersed polymers serve as rheology modifiers/adjustment for contour crafting. In still other embodiments, dispersed polymers serve as ‘sub-nano’ reinforcement for GPCs so as to effectively make the materials less brittle.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

What is claimed is:

1. A method of producing lignocellulosic composite material, the method comprising:
producing a first lignocellulosic composite product by a first lignocellulosic composite production process, wherein the first lignocellulosic composite production process produces a byproduct;
utilizing the byproduct of the first lignocellulosic composite production process in a second process to create a second product;

2. The method of claim 1, wherein the second product is a geopolymer composite material and the second process is a geopolymer composite material production process.

3. The method of claim 1, wherein the second product is a lignocellulosic composite material and the second process is a second lignocellulosic composite production process.

4. The method of claim 1, wherein the byproduct of the first lignocellulosic composite production process is a diluted version of an activating solvent used in the first lignocellulosic composite production process.

5. The method of claim 1, wherein the byproduct comprises Group I cations, hydroxide anions and urea additives.

6. The method of claim 5, wherein the byproduct further comprises silicate (SiO₂).

7. The method of claim 1, wherein a silicate (SiO₂) is added to the byproduct before utilizing the byproduct in the second process to create the second product.

8. A method of producing lignocellulosic composite material, the method comprising:
utilizing a solution for first lignocellulosic composite production process; and
utilizing the solution for a second process.

9. The method of claim 7, wherein the second process comprises a second lignocellulosic composite production process different from the first lignocellulosic composite production process.

10. The method of claim 7, wherein the second process comprises a geopolymer composite production process.

11. A method of producing a product that comprises lignocellulosic composite material and geopolymer composite material, the method comprising:
producing a lignocellulosic composite product by a lignocellulosic composite production process; and
adding geopolymer composite material to the lignocellulosic composite product by a geopolymer composite production process.

12. The method of claim 10, wherein the adding geopolymer composite material to the lignocellulosic composite product comprises coating the lignocellulosic composite product with the geopolymer composite material.
